(19) United States
(12) Patent Application Publication
(10) Pub. No.: US 2019/0138848 A1
(43) Pub. Date: May 9, 2019

(54) REALISTIC SENSOR SIMULATION AND PROBABILISTIC MEASUREMENT CORRECTION

(71) Applicant: Intel Corporation, Santa Clara, CA (US)

(72) Inventors: David I. Gonzalez Aguirre, Hillsboro, OR (US); Maria Soledad Elli, Hillsboro, OR (US); Ignacio Alvarez, Portland, OR (US); Javier Felip Leon, Hillsboro, OR (US)

(21) Appl. No.: 16/236,454

(22) Filed: Dec. 29, 2018

(51) Int. Cl. G06K 9/62; G06N 3/08

(52) U.S. Cl. CPC G06K 9/6255; G06K 9/726; G06K 9/6202; G06N 3/084

(57) ABSTRACT

Systems, apparatuses and methods may provide for technology that obtains a neural network output, which estimates a difference between a first measured output of a sensor and a simulated output of the sensor. The technology may also add the difference to the simulated output of the sensor. In one example, the neural network output includes mean displacement data and parametrically controllable covariance data. Additionally, the technology may subtract a point-wise difference from a second measurement output of the sensor.

### TECHNICAL FIELD

Embodiments generally relate to sensors. More particularly, embodiments relate to realistic sensor simulation and probabilistic measurement correction.

### BACKGROUND

Simulators may be used to model real world environments for a wide variety of applications. For example, the design of an automated navigation system for an autonomous vehicle (AV) might involve testing the system in a simulator prior to deployment. In such a case, the simulator may use a virtual lidar (light detection and ranging) sensor to emulate the operation of a physical lidar sensor to be mounted to the AV in the real world environment. The virtual lidar sensor typically uses ray tracing techniques to detect and/or classify nearby objects in the virtual world. The ray tracing techniques may rely on geometric principles that fail to account for the effect that environmental conditions (e.g., weather, sunlight, temperature) and object material characteristics (e.g., diffraction, absorption, etc.) have on the measurements of the physical lidar sensor. Accordingly, the sensor output may be too idealized, which gives rise to reliability concerns. For example, the automated navigation system might be trained on sensor data that is more accurate than the sensor data available upon deployment in the real world environment.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a comparative view of a real world environment and a virtual world environment according to an embodiment;

FIG. 2 is a block diagram of an example of a dataset according to an embodiment;

FIG. 3A is a block diagram of an example of a neural network according to an embodiment;

FIG. 3B is a flowchart of an example of a method of training a neural network according to an embodiment;

FIG. 4A is a block diagram of an example of a simulated point cloud adjustment according to an embodiment;

FIG. 4B is a more detailed block diagram of an example of a simulated point cloud adjustment according to an embodiment;

FIG. 4C is a flowchart of an example of a method of making a simulated sensor output adjustment according to an embodiment;

FIG. 5A is a block diagram of an example of a measured point cloud adjustment according to an embodiment;

FIG. 5B is a more detailed block diagram of an example of a measured point cloud adjustment according to an embodiment;

FIG. 5C is a flowchart of an example of a method of making a measured sensor output adjustment according to an embodiment;

FIG. 6 is a block diagram of an example of a performance-enhanced computing system according to an embodiment; and

FIG. 7 is an illustration of an example of a semiconductor package apparatus according to an embodiment.

### DESCRIPTION OF EMBODIMENTS

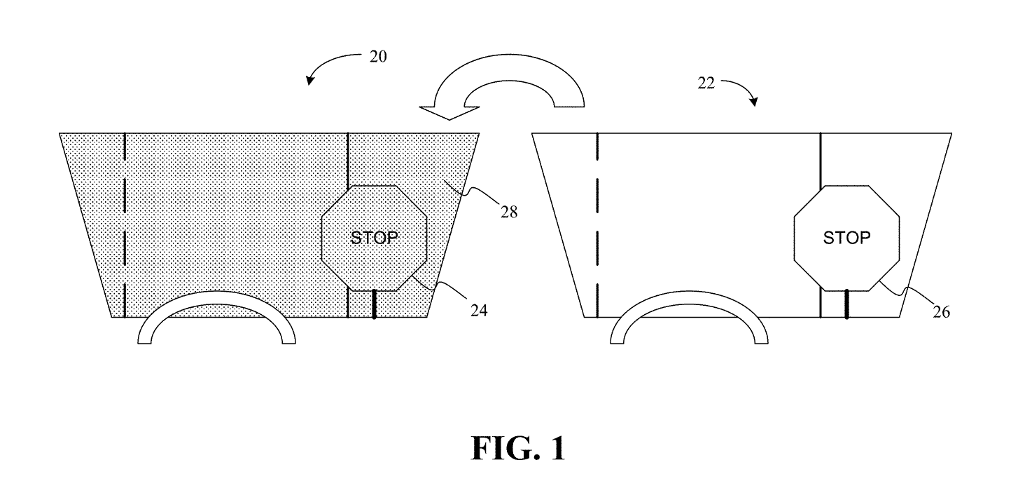

Turning now to FIG. 1, a comparative view of a real world environment 20 and a virtual (e.g., synthetically generated) world environment 22 is shown, wherein the virtual world environment 22 generally models the real world environment 20. For example, the virtual world environment 22 might be displayed in a simulator to facilitate the design and/or testing of an automated navigation system for an autonomous vehicle (AV), whereas the real world environment 20 represents the actual view from the AV after deployment. Other applications may also be used.

In the illustrated example, the view is from the perspective of a vehicle cabin (e.g., driver seat, pilot seat, etc.). In an embodiment, a physical ranging sensor such as, for example, a physical lidar sensor, radar (radio detection and ranging) sensor, sonar (sound navigation and ranging) sensor, etc., is used to automatically detect and/or classify objects in the real world environment 20. For example, a physical lidar sensor (e.g., mounted to the roof of the AV) may emit a focused light beam (e.g., outbound optical pulse transmitted in a 360° Field of View/FOV) and measure the time-of-flight of one or more optical reflections (e.g., inbound reflections) to detect the presence, shape, etc., of a physical stop sign 24 in the real world environment 20.

By contrast, a virtual ranging sensor such as, for example, a virtual lidar, radar, sonar, etc., may be used to render objects in the virtual world environment 22. In an embodiment, the virtual ranging sensor uses predetermined information regarding the virtual world environment 22 and ray tracing techniques to determine whether objects such as, for example, a virtual stop sign 26 in the virtual world environment 22 are visible from the perspective of the vehicle cabin or occluded from view.

Of particular note is that environmental conditions such as, for example, weather, sunlight, temperature, etc., may have an impact on the visual appearance of the real world environment 20. These environmental factors might be partially accounted for in the simulation, but differences might occur from reality in the performance of the virtual and physical sensors. In the illustrated example, the presence of fog 28 results in the physical stop sign 24 being partially occluded from view. Accordingly, the output of the physical ranging sensor may be relatively noisy. More particularly, the sensor noise is due to the fog 28 changing the path of outbound optical pulses and/or inbound reflections, outbound radio pulses and/or inbound reflections, and so forth. In an embodiment, the appearance of the real world environment 20 is also dependent on other environmental conditions such as temperature. For example, temperature variations throughout the day, from season-to-season, or across years (e.g., due to climate change), may change the way light, radio waves and/or sound is scattered in the real world environment 20. Indeed, other conditions such as, for example, object material characteristics (e.g., diffraction, absorption, etc.) may also have an impact on the output of the physical ranging sensor. For example, wood typically exhibits different scattering behavior than metal.

The virtual ranging sensor typically does not consider the various environmental conditions that might arise in the real world environment 20. For example, the type of material that the physical stop sign 24 is made of may not be known or taken into consideration when ray tracing is conducted with respect to the virtual stop sign 26. Accordingly, the illustrated virtual world environment 22 is rendered without the impact of, for example, the fog 28 and objects such as the virtual stop sign 26 are not partially occluded from view. Even if a probability density function were to be applied to the output of the virtual ranging sensor, the result still only be dependent on the geometry of the virtual world environment 22.

As will be discussed in greater detail, machine learning (e.g., convolutional neural network/CNN) technology may learn, infer and/or estimate the difference between the measured output of the sensor and the simulated output associated with the sensor. For example, a non-autonomous vehicle equipped with the physical ranging sensor and one or more cameras might be operated through the real world environment 20, wherein the camera(s) generate reference data such as, for example, color image samples, depth map samples, semantic classification samples, and so forth. A neural network may be trained with the measured output of the sensor and the reference data (e.g., color image samples, depth map samples, semantic classification samples, etc., from the simulator), wherein the output of the neural network estimates (e.g., infers) the difference between the measured output of the sensor and the simulated output associated with the sensor. Moreover, the difference may be used to adjust the simulated output associated with the sensor so that the virtual world environment 22 is more realistic. Indeed, an embodiment involves using the trained neural network to correct subsequent measurements of the physical sensor in a probabilistic fashion.

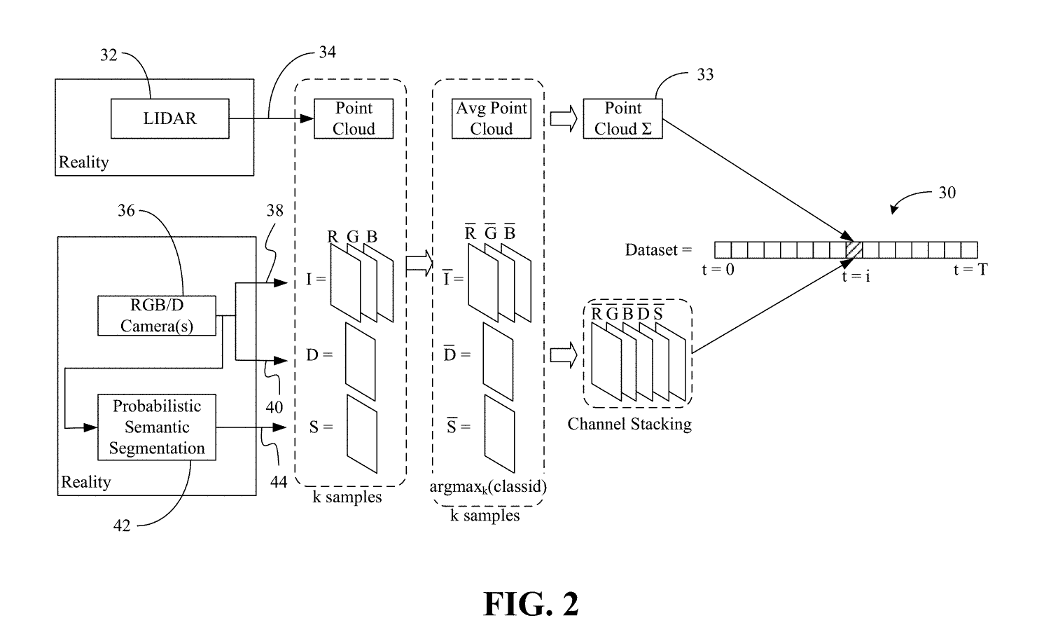

FIG. 2 shows a dataset 30 that is used to learn the difference (e.g., gap) between the data produced by a simulator and data produced by a physical (e.g., “real”) sensor. In general, the data capture process involves T sets of K samples of the same scene that are then “averaged” to document the intrinsic characteristics of a physical ranging sensor such as, for example, a lidar sensor 32. In the illustrated example, the lidar sensor 32 generates a point cloud 34 (e.g., point cloud scan, P) and one or more cameras 36 generate color (e.g., red, green, blue/RGB) images 38 (I) and depth maps 40 (D). Additionally, a semantic segmentation subsystem 42 conducts an automated analysis of the color images 38 and depth maps 40 to visually classify the content. In such a case, the dataset 30 contains the information from the RGB images 38, semantic segmentation maps 44 (S), the depth maps 40, and a covariance matrix 33 (E) associated with the point cloud 34. For this, T sets of K samples are captured and the information is organized in the following way:

For each set sₜ, k samples of the same scene are captured with the lidar sensor 32 and the camera(s) 36. The lidar sensor 32 generates N number of points for each sample k; N depending on the sensor specifications. The camera(s) 36 have a resolution of W×H pixels, where W and H are the width and height of the image respectively. The kₜₕ sample of the tₜₕ set is defined as:

sₖ^{t}={(P,I,D,S),P∈ [symbol] ^{3×N},I∈ [symbol] ^{W×H×3},D∈ [symbol] ^{W×H},S∈ [symbol] ₀^{W×H}}

with t=0, . . . , T−1, and k=0, . . . , K−1, where class labels may be unsigned integers [symbol] ₀.

Each data point in the dataset sₜ is obtained by collapsing its k samples as follows. First, the average values of each image vector are computed (Ī, D̅). Second, a pixel-wise histogram of class labels (e.g., there exists M different classes such as, for example, pedestrian, tree, concrete, car, bicycle, and so forth) is computed to obtain the pixel-wise mode label for the semantic map (S̅). For example, the label may be assigned the most prevalent class for each pixel. Finally, the mean and covariance of each lidar measurement are computed yielding (P̅, Σ∈ [symbol] ^{3×3}). Therefore, each dataset sample is described by:

sₜ={P̅,Σ,Ī,D̅,S̅}

Each of the components of sₜ contain per-pixel information and are presented to a “delta” neural network (ΔNN) as stacked data channels.

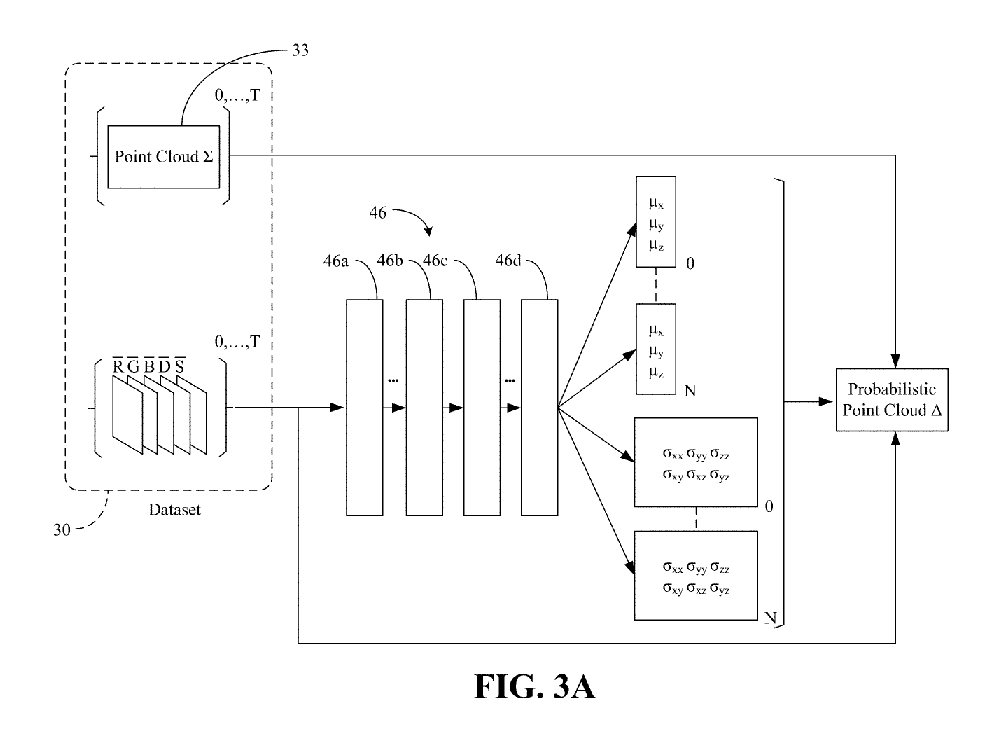

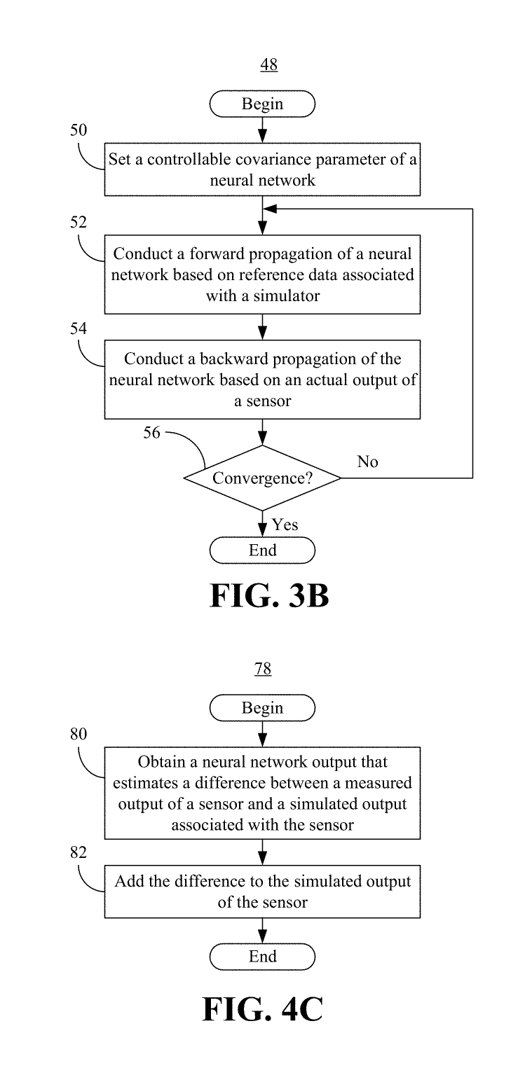

Turning now to FIG. 3A, a neural network 46 (46a-46d) including a first convolutional layer 46a through i^{th} convolutional layer 46b, and a first fully connected layer 46c through j^{th} fully connected layer 46d, and so forth. In an embodiment, the neural network 46 is trained to be dependent on the sensor rather than the scene being sensed or simulated. To train the neural network 46, xₜ={Ī, D̅, S̅}ₜ (e.g., reference data) are used as inputs for one or more forward propagations (e.g., forward passes moving from input to output), which computes a gradient of a loss function with respect to current weights. Additionally, one or more backward propagations (e.g., backward passes moving from output to input) use yₜ={P̅, Σ}ₜ (e.g., measured output, ground truth data) as a supervisory signal and desired output to update the current weights in a manner that reduces the value of the loss function. The training process yields a ΔNN that consumes depth, RGB and semantic maps and provides the gap between the simulation and reality in the form of a vector of mean displacements P̅ for each lidar point and its symmetric covariance matrix Σ as the measure of uncertainty. In the illustrated example, the symmetry of the covariance matrix enables only the upper triangular elements to be encoded, which reduces processing overhead and further enhances performance.

FIG. 3B shows a method 48 of training a neural network such as, for example, the neural network 46 (FIG. 3A), already discussed. The method 48 may generally be implemented in a simulator or other computing system that renders a virtual world environment such as, for example, the virtual world environment 22 (FIG. 1), already discussed. More particularly, the method 48 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 48 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 50 provides for setting a controllable covariance parameter of the neural network. More particularly, the covariance inferred for each point after training may be used to dynamically generate stochastic variations for each single scan of the sensor. Accordingly, using a distance metric such as, for example, the Mahalanobis distance (e.g., quantifying how many standard deviations away a point P is from the mean of a distribution D), for each point it is possible to draw a family of samples Pⱼ based on the mean point Pᵢ:=(μx, μy, μz) and the covariance Σⱼ matrix. The advantage of deriving the point from such a formulation is that the uncertainty can be parametrically controlled by a scalar factor λ and the Eigen values from the singular value decomposition SVD(Σⱼ)ᵤ:

Pⱼ(Pᵢ,λ)=(μxᵢ,μyᵢ,μzᵢ)+λ(SVD(Σⱼ)ᵤ^{1/2}λdiag(rand[−1,1],rand[−1,1],rand[−1,1]))

As will be discussed in greater detail, this formulation may enable the accuracy decay and robustness of each system (e.g., automated navigation system instance) to be analyzed in a sound and formally complete manner. In other words, the simulated output associated with the sensor may be transformed in a more realistic model, characterized by the parameter λ.

A forward (e.g., input to output) propagation of the neural network is conducted at illustrated block 52 based on reference data (e.g., color image samples, depth map samples, semantic classification samples) associated with the simulator. In an embodiment, block 52 includes computing a gradient of a loss function with respect to current weights of the neural network layers. More particularly, block 52 may include averaging color image samples on a per point basis, averaging depth map samples on a per point basis, and generating a histogram of semantic classification samples on a per point basis. Additionally, a backward (e.g., output to input) propagation of the neural network may be conducted at block 54 based on the actual output of the sensor. In an embodiment, block 54 includes updating the current weights in a manner that reduces the value of the loss function. Block 56 determines whether the loss function has converged to an acceptable value. If not, the illustrated method 48 returns to block 52. Otherwise, the method 48 may terminate. The resulting neural network is configured to estimate the difference between the measured output of the sensor and the simulated output associated with the sensor.

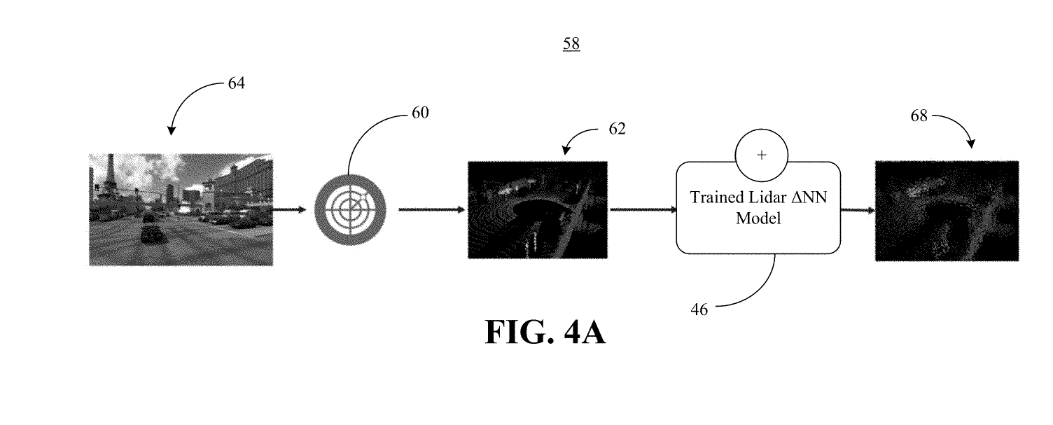

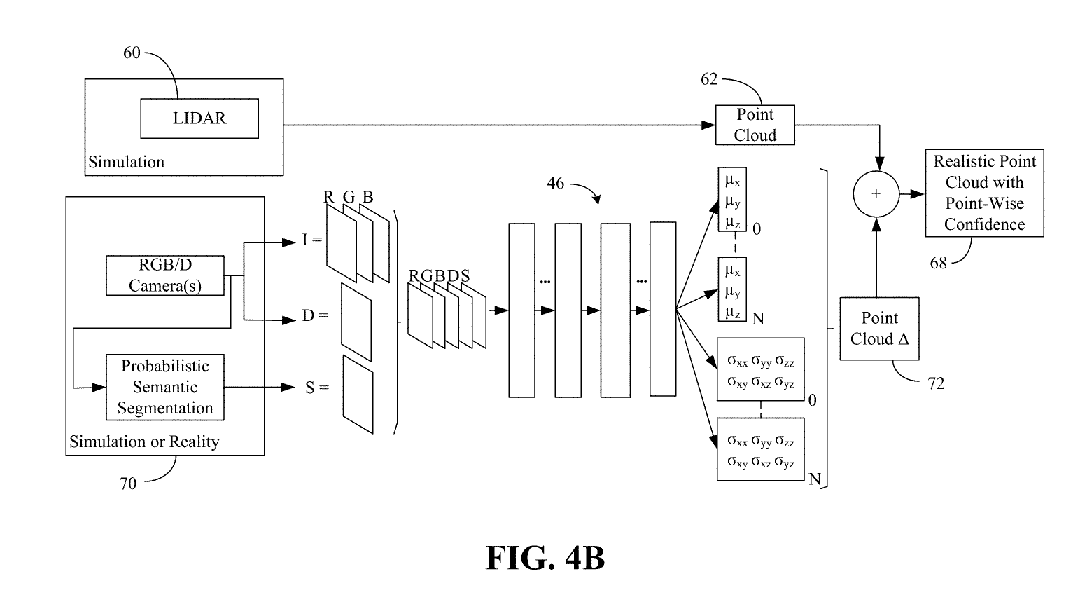

FIG. 4A shows a simulated point cloud adjustment 58 in which a virtual lidar sensor 60 (e.g., modeling a physical lidar sensor, not shown) generates a simulated point cloud 62 (e.g., in an “offline” setting) based on a simulated world 64. As already noted, the virtual lidar sensor 60 may use ray tracing techniques that rely solely on geometric principles and fail to account for the affect that environmental conditions (e.g., weather, sunlight, temperature) and object material characteristics (e.g., diffraction, absorption, etc.) have on the simulated point cloud 62. Accordingly, the simulated point cloud 62 is too idealistic (e.g., lacks noise that would be present in a real world environment). In an embodiment, the neural network 46 (e.g., a trained delta neural network/ΔNN), estimates the difference (e.g., increment) between a measured point cloud (e.g., for the same scene) of the physical lidar sensor and the simulated point cloud 62. The output/increment of the neural network 46 is added to the simulated point cloud 62 to obtain a modified (e.g., “hyper-realistic”) point cloud 68. The modified point cloud 68 obviates reliability concerns and enhances performance. For example, an automated navigation system might be trained on sensor data that is similar to (e.g., in terms of accuracy) the sensor data available upon deployment in the real world environment.

Turning now to FIG. 4B, a more detailed view of a simulated point cloud adjustment is shown. In the illustrated example, the neural network 46 outputs a point cloud difference 72 based on reference data 70 (e.g., simulation or reality). The difference 72 may be added to the simulated point cloud 62 to obtain the modified point cloud 68, which is realistic and has point-wise confidence information.

FIG. 4C shows a method 78 of making a simulated sensor output adjustment. The method 78 may generally be implemented in a simulator or other computing system that renders a virtual world environment such as, for example, the virtual world environment 22 (FIG. 1) and/or the simulated world 64 (FIG. 4A), already discussed. More particularly, the method 78 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 80 obtains a neural network such as, for example, the neural network 46 (FIGS. 3A, 4A and 4B) that estimates the difference between the measured output of a sensor and a simulated output associated with the sensor. More particularly, the neural network output may include mean displacement data (e.g., μₓ, μ_{y}, μ_{z} for N points) and parametrically controllable covariance data (e.g., σₓₓ, σ_{yy}, σ_{zz}, σ_{xy}, σ_{xz}, σ_{yz} for N points). In embodiment, block 80 includes training, retrieving and/or receiving the neural network, depending on the circumstances. The difference is added to the simulated output associated with the sensor at block 82 to obtain a more realistic sensor output. Of particular note is that the method 78 may be repeated for different values of the controllable variance parameter (e.g., λ discussed above) to evaluate the effects of sensor decay over time. For example, increasing the difference between the measured output and the simulated output enables the analysis of the ability of, for example, an autonomous vehicle to operate safely under deteriorating sensing conditions over time.

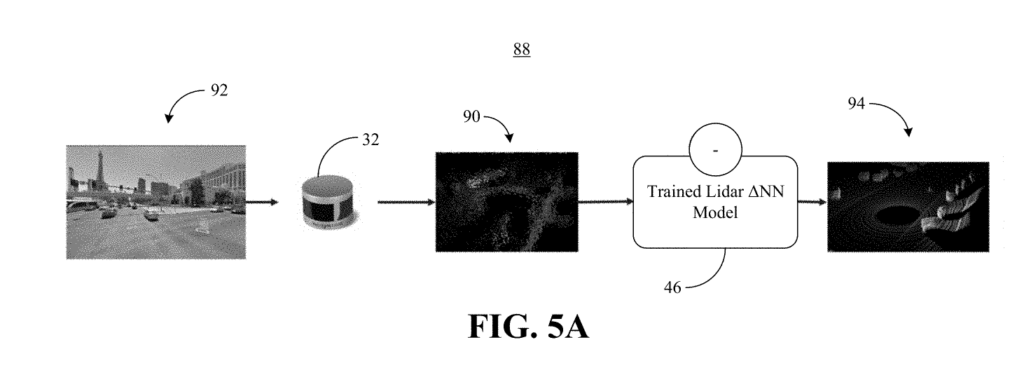

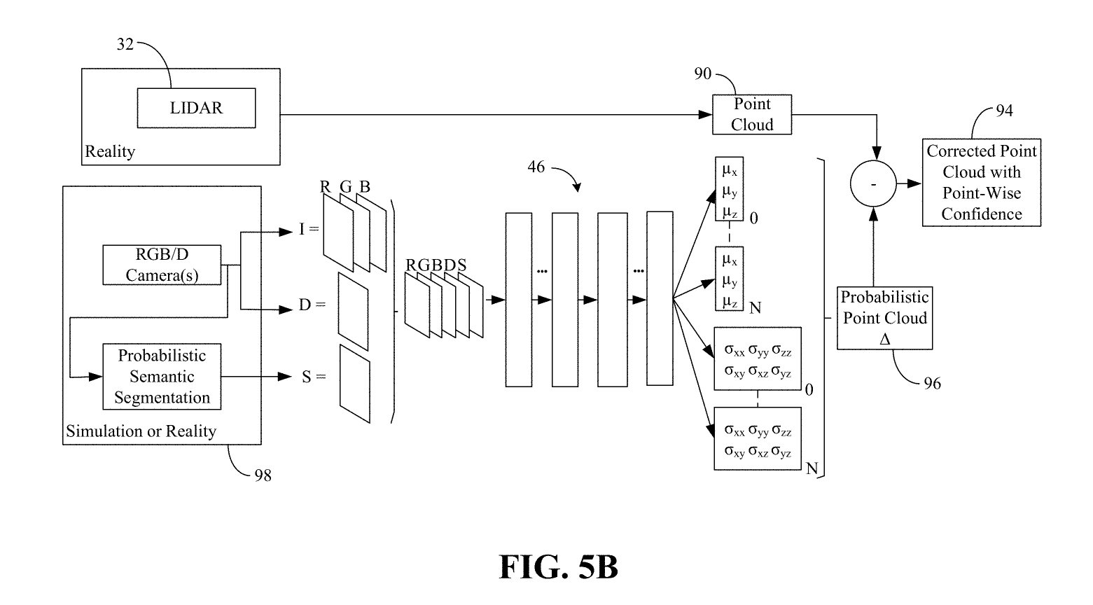

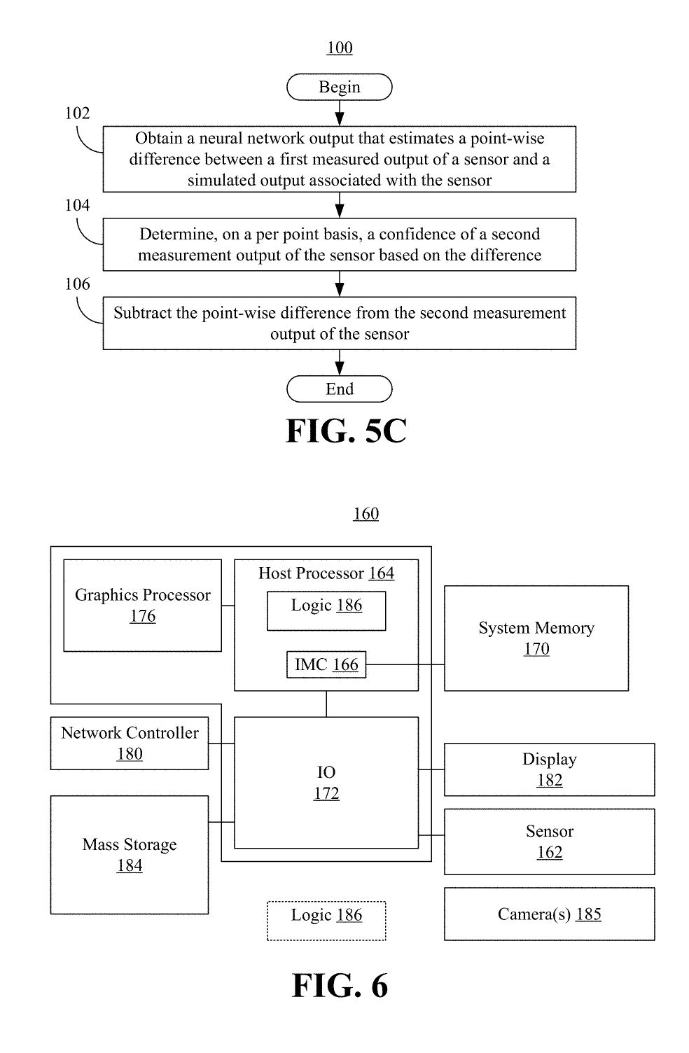

FIG. 5A shows a measured point cloud adjustment 88 in which a physical lidar sensor 32 generates a measured point cloud 90 (e.g., in an “online” setting) based on a real world environment 92. As already noted, the physical lidar sensor 32 may emit a focused light beam (e.g., outbound optical pulse transmitted in a 360° FOV) and measure the time-of-flight of one or more optical reflections (e.g., inbound reflections) to detect the presence, shape, etc., of physical objects in the real world environment 92. Moreover, the trained neural network 46 may generate an output that estimates a point-wise difference between a previous point cloud (not shown) obtained from the lidar sensor 32 and a simulated point cloud (not shown) associated with the lidar sensor 32. In the illustrated example, the point-wise difference is subtracted from the measured point cloud 90 to obtain a modified point cloud 94 (e.g., the point cloud with the maximal associated confidence per point, namely the most probable point cloud). The illustrated solution therefore reduces sensor noise. Indeed, the modified point cloud 94 may be used in sensor fusing techniques to build virtual environment representations for autonomous systems and to create virtual worlds from real data.

FIG. 5B shows a more detailed view of a measured point cloud adjustment. In the illustrated example, the neural network 46 outputs a point cloud difference 96 based on reference data 98 (e.g., simulation or reality). The difference 96 may be subtracted from the measured point cloud 90 to obtain the modified point cloud 94, which is corrected with point-wise difference information.

More particularly, the illustrated solution exploits the learned uncertainty and noise behavior of the physical lidar sensor 32, via ΔNN training, to improve the measurements of the lidar sensor 32. This enhancement procedure may be accomplished in two phases.

First, using the RGBD cameras and associated semantic segmentation information, the neural network 46 generates an expected probabilistic point cloud. In this set, each point is described as a three-dimensional (3D) Gaussian distribution. Thus, it is possible to compare (e.g., via registration and closest point calculation in Euclidean distance) each point obtained with the physical lidar sensor 32 against the corresponding point generated by the neural network 46. In an embodiment, the deviation distance is once again the Mahalanobis distance Γ(Pᵢ). Therefore, the normalized confidence Γ(Pᵢ) for each point is expressed as:

$$Γ ( {P}_{i} ) := 1 - \frac{{M ( Pi )}^{2}}{3} if Γ ( Pi ) \geq 3 , else 0$$

A relatively large Mahalanobis distance indicates low confidence, whereas a relatively small Mahalanobis distance indicates a high confidence. This confidence information, which is determined on a per point basis, may be very valuable for many systems (e.g., automated navigation systems) because it expresses which regions of the environment have been sampled more reliably. Indeed, the confidence information may be incorporated into the probabilistic frameworks of localization, segmentation and motion estimation technology. Moreover, the point-wise nature of the confidence information may enable the full frame rate of the sensor to be leveraged in a real-time setting. The confidence value per point Pᵢ may also lead to the second phase.

The second phase is to use the inverse equation the off-line mode to correct (e.g., remove uncertainty from) the points captured with the physical lidar sensor 32, as already noted. The correction parameter is actually Ω=λ⁻¹. This approach therefore enables the enhancement of real sensing signals with the deep learned stochastic behavior of each specific sensor instance in order to improve the overall digitalization in terms of accuracy and reliability.

FIG. 5C shows a method 100 of making a measured sensor output adjustment.

The method 100 may generally be implemented in a physical sensor such as, for example, the lidar sensor 32 (FIGS. 2, 5A and 5B), already discussed. More particularly, the method 100 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 102 obtains a neural network such as, for example, the neural network 46 (FIGS. 3A, 4A and 4B) that estimates a point-wise difference between a first measured output of a sensor and a simulated output associated with the sensor. In an embodiment, the neural network output includes mean displacement data and parametrically controllable covariance data. Moreover, block 102 may include inputting reference data to a trained neural network to obtain the neural network output. Block 104 determines, on a per point basis, the confidence of a second measurement output of the sensor based on the difference, wherein the point-wise difference is subtracted at block 106 from the second measurement output of the sensor. The illustrated method 100 therefore provides for probabilistic measurement corrections in real-time.

Turning now to FIG. 6, a performance-enhanced computing system 160 is shown. In the illustrated example, the system 160 includes a physical sensor 162 (e.g., lidar, radar, sonar) and a host processor 164 (e.g., central processing unit/CPU with one or more processor cores) having an integrated memory controller (IMC) 166 that is coupled to a system memory 170. The illustrated system 160 also includes an input output (IO) module 172 implemented together with the host processor 164 and a graphics processor 176 on a semiconductor die 178 as a system on chip (SoC). The IO module 172 communicates with, for example, a network controller 180 (e.g., wireless, wired), a display 182, the sensor 162, one or cameras 185 (e.g., RGB, depth, etc., with scene segmentation capabilities) and mass storage 184 (e.g., hard disk drive/HDD, optical disk, solid state drive/SSD, flash memory).

The host processor 164 may include logic 186 (e.g., logic instructions, configurable logic, fixed-functionality hardware logic, etc., or any combination thereof) to perform one or more aspects of the method 48 (FIG. 3B), the method 78 (FIG. 4C), and/or the method 100 (FIG. 5C), already discussed. Thus, the logic 186 may train a neural network with the measured output of the sensor 162 and reference data from the camera(s) 185, wherein the trained neural network estimates the difference between a measured output of the sensor 162 and a simulated output associated with the sensor 162. In an embodiment, the reference data is tailored to the type of sensor 162 being used. For example, a lidar sensor might be used with RGB, depth and segmentation data, whereas reflectance, impedance and/or absorption measurements may be used as reference data for a radar sensor. Similarly, density measurements and/or other sensor-specific input modalities might be used as reference data for a sonar sensor. The simulated output may be received from, for example, the graphics processor 176. In an embodiment, the logic 186 also obtains a neural network output from the trained neural network and adds the difference to the simulated output associated with the sensor 162.

Additionally, the logic 186 may obtain a neural network output that estimates a point-wise difference between a first measured output of the sensor 162 and a simulated output of the sensor 162 and determines, on a per point basis, the confidence of a second measurement output of the sensor based on the difference. In an embodiment, the logic 186 also subtracts the point-wise difference from the second measurement output of the sensor. The illustrated system 160 therefore exhibits enhanced performance due to more realistic simulation of the sensor 162 and/or more accurate readings from the sensor 162. Although the logic 186 is shown in the host processor 164, the logic 186 may be located elsewhere in the system 160.

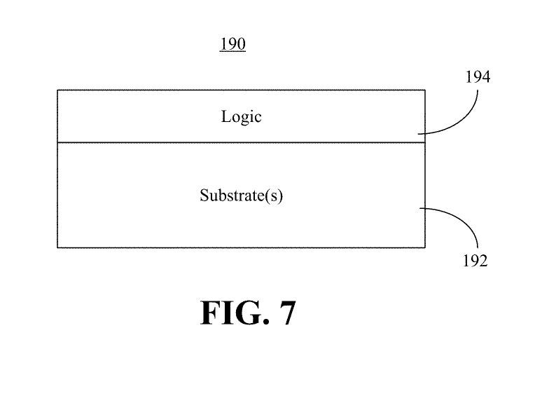

FIG. 7 shows a semiconductor package apparatus 190. The apparatus 190 may include logic 194 to implement one or more aspects of the method 48 (FIG. 3B), the method 78 (FIG. 4C), and/or the method 100 (FIG. 5C), already discussed, and may be readily substituted for the logic 186 (FIG. 6), already discussed. The illustrated apparatus 190 includes one or more substrates 192 (e.g., silicon, sapphire, gallium arsenide), wherein the logic 194 (e.g., transistor array and other integrated circuit/IC components) is coupled to the substrate(s) 192. The logic 194 may be implemented at least partly in configurable logic or fixed-functionality logic hardware. In one example, the logic 194 includes transistor channel regions that are positioned (e.g., embedded) within the substrate(s) 192. Thus, the interface between the logic 194 and the substrate(s) 192 may not be an abrupt junction. The logic 194 may also be considered to include an epitaxial layer that is grown on an initial wafer of the substrate(s) 192.

### ADDITIONAL NOTES AND EXAMPLES

Example 1 includes a semiconductor apparatus comprising one or more substrates and logic coupled to the one or more substrates, wherein the logic is implemented at least partly in one or more of configurable logic or fixed-functionality hardware logic, the logic coupled to the one or more substrates to obtain a neural network output that estimates a difference between a measured output of a sensor and a simulated output associated with the sensor and add the difference to the simulated output associated with the sensor.

Example 2 includes the semiconductor apparatus of Example 1, wherein the neural network output includes mean displacement data and parametrically controllable covariance data.

Example 3 includes the semiconductor apparatus of Example 1, wherein the logic coupled to the one or more substrates is to train a neural network with the measured output of the sensor and reference data, and wherein the neural network output is obtained from the trained neural network.

Example 4 includes the semiconductor apparatus of Example 3, wherein the logic coupled to the one or more substrates is to conduct one or more forward propagations of the neural network based on the reference data, and conduct one or more backward propagations of the neural network based on the measured output of the sensor to train the neural network.

Example 5 includes the semiconductor apparatus of Example 3, wherein the reference data is associated with a simulator and includes one or more of color image samples, depth map samples or semantic classification samples.

Example 6 includes the semiconductor apparatus of Example 5, wherein the logic is to average the color image samples on a per point basis, average the depth map samples on a per point basis, and generate a histogram of the semantic classification samples on a per point basis.

Example 7 includes the semiconductor apparatus of Example 1, wherein the simulated output is a simulated point cloud and the measured output is a measured point cloud.

Example 8 includes the semiconductor apparatus of Example 1, wherein the logic coupled to the one or more substrates is to input reference data to a trained neural network to obtain the neural network output.

Example 9 includes at least one computer readable storage medium comprising a set of instructions, which when executed by a computing system, cause the computing system to obtain a neural network output that estimates a difference between a measured output of a sensor and a simulated output associated with the sensor, and add the difference to the simulated output associated with the sensor.

Example 10 includes the at least one computer readable storage medium of Example 9, wherein the neural network output includes mean displacement data and parametrically controllable covariance data.

Example 11 includes the at least one computer readable storage medium of Example 9, wherein the instructions, when executed, cause the computing system to train a neural network with the measured output of the sensor and reference data, and wherein the neural network output is obtained from the trained neural network.

Example 12 includes the at least one computer readable storage medium of Example 11, wherein the instructions, when executed, cause the computing system to conduct one or more forward propagations of the neural network based on the reference data, and conduct one or more backward propagations of the neural network based on the measured output of the sensor to train the neural network.

Example 13 includes the at least one computer readable storage medium of Example 11, wherein the reference data is associated with a simulator and includes one or more of color image samples, depth map samples or semantic classification samples.

Example 14 includes the at least one computer readable storage medium of Example 13, wherein the instructions, when executed, cause the computing system to average the color image samples on a per point basis, average the depth map samples on a per point basis, and generate a histogram of the semantic classification samples on a per point basis.

Example 15 includes the at least one computer readable storage medium of Example 9, wherein the simulated output is a simulated point cloud and the measured output is a measured point cloud.

Example 16 includes the at least one computer readable storage medium of Example 9, wherein the instructions, when executed, cause the computing system to input reference data to a trained neural network to obtain the neural network output.

Example 17 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to obtain a neural network output that estimates a point-wise difference between a first measured output of a sensor and a simulated output associated with the sensor, and determine, on a per point basis, a confidence of a second measurement output of the sensor based on the difference.

Example 18 includes the semiconductor apparatus of Example 17, wherein the logic coupled to the one or more substrates is to subtract the point-wise difference from a second measurement output of the sensor.

Example 19 includes the semiconductor apparatus of Example 17, wherein the neural network output includes mean displacement data and parametrically controllable covariance data.

Example 29 includes the semiconductor apparatus of Example 17, wherein the logic coupled to the one or more substrates is to input reference data to a trained neural network to obtain the neural network output.

Example 21 includes at least one computer readable storage medium comprising a set of instructions, which when executed by a computing system, cause the computing system to obtain a neural network output that estimates a point-wise difference between a first measured output of a sensor and a simulated output associated with the sensor, and determine, on a per point basis, a confidence of a second measurement output of the sensor based on the difference.

Example 22 includes the at least one computer readable storage medium of Example 21, wherein the instructions, when executed, cause the computing system to subtract the point-wise difference from a second measurement output of the sensor.

Example 23 includes the at least one computer readable storage medium of Example 21, wherein the neural network output includes mean displacement data and parametrically controllable covariance data.

Example 24 includes the at least one computer readable storage medium of Example 21, wherein the instructions, when executed, cause the computing system to input reference data to a trained neural network to obtain the neural network output.

Thus, technology described herein may improve the realism of synthetically generated data in simulators by generating a model that learns the behavior of real sensors and performs a transformation of virtual input to the desired deterministic sensor. Such an approach enables the capture of realistic sensor data in a simulator without affecting the virtual world rendering. Furthermore, a reverse application of the approach can be used on real data captures to reduce signal noise perceived by sensors.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
obtain a neural network output that estimates a difference between a measured output of a sensor and a simulated output associated with the sensor; and
add the difference to the simulated output associated with the sensor.

2. The semiconductor apparatus of claim 1, wherein the neural network output includes mean displacement data and parametrically controllable covariance data.

3. The semiconductor apparatus of claim 1, wherein the logic coupled to the one or more substrates is to train a neural network with the measured output of the sensor and reference data, and wherein the neural network output is obtained from the trained neural network.

4. The semiconductor apparatus of claim 3, wherein the logic coupled to the one or more substrates is to:
conduct one or more forward propagations of the neural network based on the reference data; and
conduct one or more backward propagations of the neural network based on the measured output of the sensor to train the neural network.

5. The semiconductor apparatus of claim 3, wherein the reference data is associated with a simulator and includes one or more of color image samples, depth map samples or semantic classification samples.

6. The semiconductor apparatus of claim 5, wherein the logic is to:
average the color image samples on a per point basis;
average the depth map samples on a per point basis; and
generate a histogram of the semantic classification samples on a per point basis.

7. The semiconductor apparatus of claim 1, wherein the simulated output is a simulated point cloud and the measured output is a measured point cloud.

8. The semiconductor apparatus of claim 1, wherein the logic coupled to the one or more substrates is to input reference data to a trained neural network to obtain the neural network output.

9. At least one computer readable storage medium comprising a set of instructions, which when executed by a computing system, cause the computing system to:
obtain a neural network output that estimates a difference between a measured output of a sensor and a simulated output associated with the sensor; and
add the difference to the simulated output associated with the sensor.

10. The at least one computer readable storage medium of claim 9, wherein the neural network output includes mean displacement data and parametrically controllable covariance data.

11. The at least one computer readable storage medium of claim 9, wherein the instructions, when executed, cause the computing system to train a neural network with the measured output of the sensor and reference data, and wherein the neural network output is obtained from the trained neural network.

12. The at least one computer readable storage medium of claim 11, wherein the instructions, when executed, cause the computing system to:
conduct one or more forward propagations of the neural network based on the reference data; and
conduct one or more backward propagations of the neural network based on the measured output of the sensor to train the neural network.

13. The at least one computer readable storage medium of claim 11, wherein the reference data is associated with a simulator and includes one or more of color image samples, depth map samples or semantic classification samples.

14. The at least one computer readable storage medium of claim 13, wherein the instructions, when executed, cause the computing system to:
average the color image samples on a per point basis;
average the depth map samples on a per point basis; and
generate a histogram of the semantic classification samples on a per point basis.

15. The at least one computer readable storage medium of claim 9, wherein the simulated output is a simulated point cloud and the measured output is a measured point cloud.

16. The at least one computer readable storage medium of claim 9, wherein the instructions, when executed, cause the computing system to input reference data to a trained neural network to obtain the neural network output.

17. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
obtain a neural network output that estimates a point-wise difference between a first measured output of a sensor and a simulated output associated with the sensor; and
determine, on a per point basis, a confidence of a second measurement output of the sensor based on the difference.

18. The semiconductor apparatus of claim 17, wherein the logic coupled to the one or more substrates is to subtract the point-wise difference from a second measurement output of the sensor.

19. The semiconductor apparatus of claim 17, wherein the neural network output includes mean displacement data and parametrically controllable covariance data.

29. The semiconductor apparatus of claim 17, wherein the logic coupled to the one or more substrates is to input reference data to a trained neural network to obtain the neural network output.

21. At least one computer readable storage medium comprising a set of instructions, which when executed by a computing system, cause the computing system to:
obtain a neural network output that estimates a point-wise difference between a first measured output of a sensor and a simulated output associated with the sensor; and
determine, on a per point basis, a confidence of a second measurement output of the sensor based on the difference.

22. The at least one computer readable storage medium of claim 21, wherein the instructions, when executed, cause the computing system to subtract the point-wise difference from a second measurement output of the sensor.

23. The at least one computer readable storage medium of claim 21, wherein the neural network output includes mean displacement data and parametrically controllable covariance data.

24. The at least one computer readable storage medium of claim 21, wherein the instructions, when executed, cause the computing system to input reference data to a trained neural network to obtain the neural network output.
